(19) United States
(12) Patent Application Publication
(10) Pub. No.: US 2012/0259591 A1
(43) Pub. Date: Oct. 11, 2012

(54) KEYBOARD TESTING METHOD

(75) Inventor: Pei-Ming Chang, Taipei (TW)

(73) Assignee: PRIMAX ELECTRONICS LTD., Taipei (TW)

(21) Appl. No.: 13/116,969

(22) Filed: May 26, 2011

(30) Foreign Application Priority Data
Apr. 8, 2011 (TW) 100112177

(51) Int. Cl. G06F 15/00

(52) U.S. Cl. 702/189

(57) ABSTRACT

A keyboard testing method is used for testing an ordinary key and a special key. The keyboard testing method includes the following steps. Firstly, receive a key message outputted from the keyboard. Then, detect the key message and judge whether the key message is a special message. If the key message is the special message, intercept the special message and convert a code of the special message. Then, judge whether the code of the converted special message is one of plural default key codes. If the key message is an ordinary message, process the ordinary message and judge whether a code of the processed ordinary message is one of the default key codes. After all keys of the keyboard have been tested, the keyboard testing method is completed. The use of the keyboard testing method of the present invention is able to test the special key of the keyboard.

### FIELD OF THE INVENTION

The present invention relates to a testing method, and more particularly to a keyboard testing method.

### BACKGROUND OF THE INVENTION

With rapid development of science and technology, computers and the peripheral devices thereof become essential parts in our daily lives. In addition to the working purposes, computers and the peripheral devices thereof can be employed as amusement tools. In a computer system, an input device plays important roles for communicating the computer with the user. The common input device of the computer system includes for example a mouse, a keyboard, a trackball, and the like. Among these input devices, the keyboard device is the most important. Via plural keys of the keyboard device, corresponding instructions may be inputted to the computer.

FIG. 1 is a schematic view illustrating the outward appearance of a conventional keyboard device. As shown in FIG. 1, plural keys 10 are installed on the surface of the conventional keyboard device 1. These keys are classified into some types, e.g. alphabetical keys 10, numeric keys 11, function keys 12 and special keys 13. The alphabetical keys 10, the numeric keys 11 and the function keys 12 are usually referred as ordinary keys. The special keys 13 are specially designed by individual manufacturer of the keyboard device 1. When one or more keys 10 are depressed by the user's fingers, a corresponding signal is issued to the computer, and thus the computer executes a function corresponding to the depressed key or keys. For example, when an alphabetical key 10 is depressed, a corresponding English letter or symbol is inputted into the computer. When a numeric key 11 is depressed, a corresponding number is inputted into the computer. In addition, the function keys 12 (e.g. F1˜F12) can be programmed to cause corresponding application programs to provide certain functions.

Moreover, the special keys 13 are specially designed to control the operating status of the keyboard itself or the operating status of the computer host. The general special keys 13 include for example a sleep key, a wake key and a power off key. In comparison with the ordinary keys, the key code formats of the special keys to be inputted into the computer host are distinguished. For example, the key code of the special key usually starts from “0x02”. Moreover, the length of the key code of the special key is usually shorter than eight bytes. For example, the key code of the sleep key is “0x02 0x02”. The key code formats of other keys start from “0x01”. In other words, the Usage Page of the special key of the USB keyboard is different from the Usage Page of the ordinary key.

As known, in the fabricating process of the keyboard device, it is necessary to perform a keyboard testing method to assure normal functions of the keyboard device. The keyboard testing method includes a procedure of testing the circuit board of the keyboard device and a procedure of testing the overall functions of the assembled keyboard device. For example, in order to test an assembled keyboard device by the conventional keyboard testing method, the keyboard device is firstly connected with a testing machine. Sequentially, the keys are manually or automatically tapped, and thus corresponding key codes are outputted from the keyboard device to the testing machine. After the key codes are received, the key codes are converted into virtual codes by the testing machine. A testing program installed in the testing machine will judge whether the virtual codes comply with corresponding correct key codes that are preset in the testing machine. After the keys are sequentially and all depressed, if the above judging condition is satisfied, the keyboard device is determined as a qualified keyboard that passes the test.

Generally, the testing machine is operated under a Microsoft Windows series operating system, and the testing program is written in a graphic editing language (e.g. Labview). In the Windows operating system, the ordinary keys have corresponding default virtual key codes. However, the key code formats of the special keys have not been previously defined under the Windows operating system of the testing machine. Since the operating system of the testing machine fails to provide the virtual key codes of the special keys, even if the special keys are depressed during the testing process, the testing process can not be successfully executed by the testing program.

### SUMMARY OF THE INVENTION

The present invention provides a keyboard testing method for testing a special key of a keyboard, wherein the special key is a sleep key, a wake key, a power off key or an eject key.

In accordance with an aspect of the present invention, there is provided a keyboard testing method for testing a special message and an ordinary message outputted from a keyboard to a host. The special message is generated by tapping at least one special key. The ordinary message is generated by tapping at least one ordinary key. The special message and the ordinary message have different key code formats. The keyboard testing method includes the following steps. In a step (A), a key message outputted from the keyboard is received. Then, a step (B) is performed to detect whether the key message outputted to the host is the special message. If the key message is the special message, a step (C) is performed. If the key message is not the special message, the key message is the ordinary message and a step (E) is performed. In the step (C), the special message is intercepted, and a code of the special message is converted. The step (D) is performed to receive the converted special message, and judge whether the code of the converted special message is one of plural default key codes. If the judging condition is satisfied, a step (F) is performed. If the judging condition is not satisfied, a testing result of the keyboard is shown. The step (E) is performed to process the ordinary message and judge whether a code of the processed ordinary message is one of the default key codes. If the judging condition is satisfied, the step (F) is performed. If the judging condition is not satisfied, a testing result of the keyboard is shown. The step (F) is performed to judge whether all keys of the keyboard have been tested. If the judging condition is satisfied, the step (A) is repeatedly done. If the judging condition is not satisfied, a testing result of the keyboard is shown.

In an embodiment, the special key is a sleep key, a wake key, a power off key or an eject key of the keyboard.

In an embodiment, the host further includes a monitor for showing icons corresponding to all keys of the keyboard.

In an embodiment, if the code of the converted special message is one of the default key codes according to the judging condition of the step (D), the keyboard testing method further includes a step of changing a color of a special key icon shown on the monitor and corresponding to the special message, thereby facilitating a user to realize the testing result.

In an embodiment, if a code of the ordinary message is one of the default key codes according to the judging condition of the step (E), the keyboard testing method further includes a step of changing a color of an ordinary key icon shown on the monitor and corresponding to the ordinary message, thereby facilitating a user to realize the testing result.

In an embodiment, the step (B) of detecting whether the key message outputted to the host is the special message and the step (C) of intercepting the special message and converting the code of the special message are executed by a message intercept program installed in the host.

In an embodiment, the step (C) of converting the code of the special message is performed by calling a special key event previously stored in the message intercept program according to a depressing status of the special message, so that a code format of the special message is converted into a format of a virtual key code.

In an embodiment, the step (D), the step (E) and the step (F) are executed by a keyboard testing program and a message intercept program installed in the host.

In an embodiment, the step of processing the ordinary message is performed by converting the ordinary message into a corresponding virtual key code.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the outward appearance of a conventional keyboard device;

FIG. 2 is a flowchart illustrating a keyboard testing method according to an embodiment of the present invention;

FIG. 3 is a schematic functional block diagram illustrating a keyboard testing system using the keyboard testing method of the present invention; and

FIG. 4 schematically illustrates the testing result shown on a monitor during the keyboard testing method according to the present invention is performed.

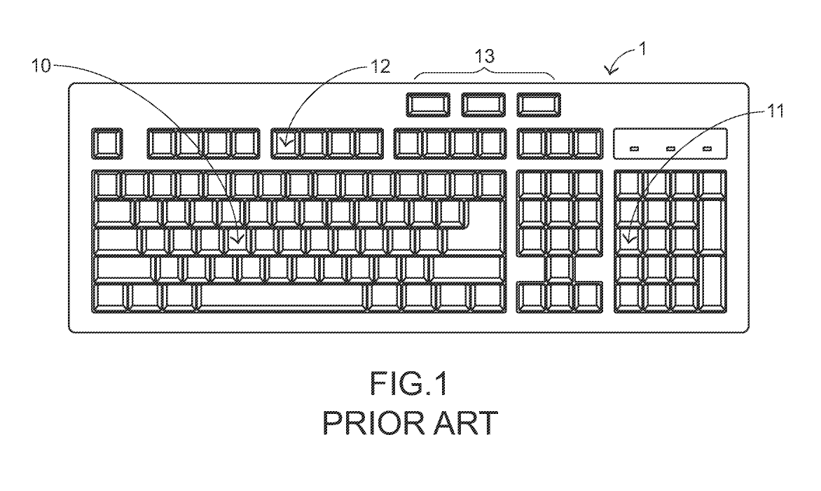

### DETAILED DESCRIPTION OF THE PREFERRED EMBODIMENT

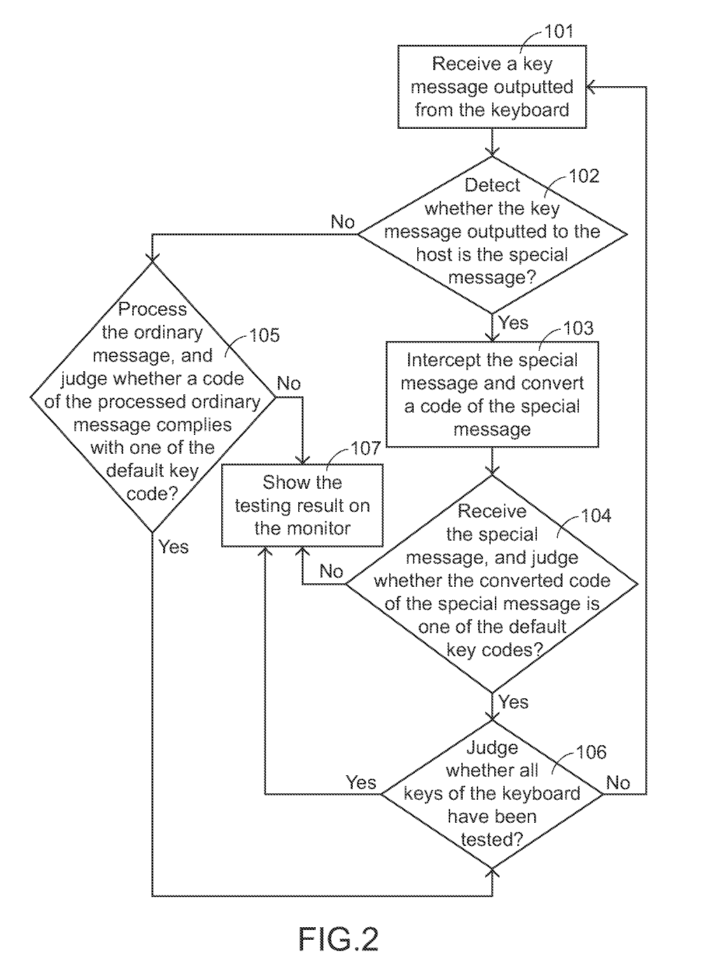

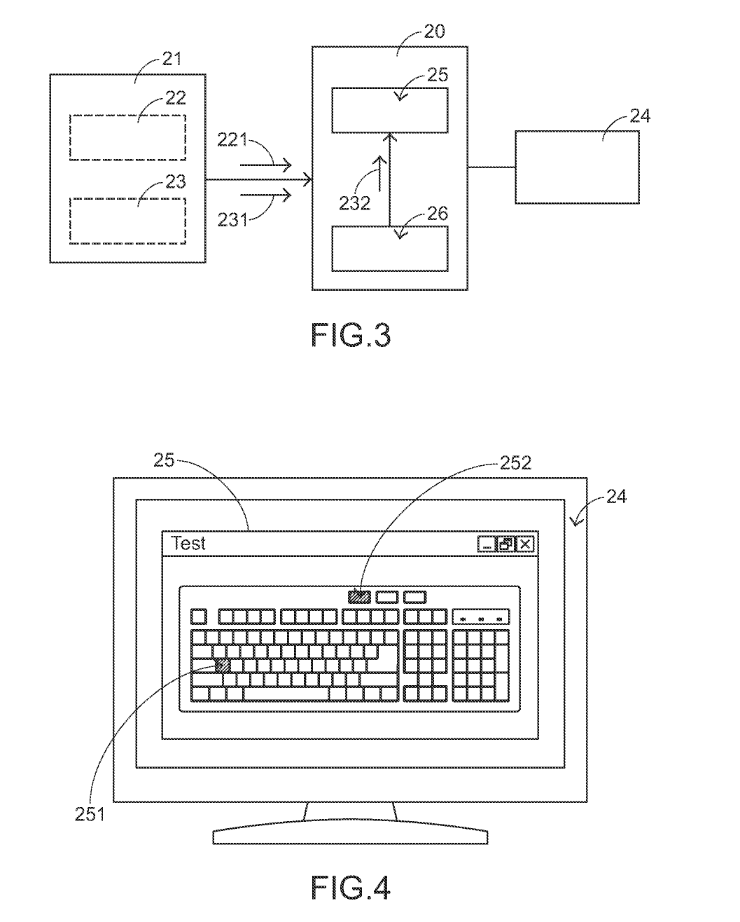

FIG. 2 is a flowchart illustrating a keyboard testing method according to an embodiment of the present invention. FIG. 3 is a schematic functional block diagram illustrating a keyboard testing system using the keyboard testing method of the present invention. Before the keyboard testing method is performed, a keyboard testing program 25 and a message intercept program 26 should be installed in a host 20. For example, the operating system of the host 20 is the widely-used Windows operating system. The keyboard testing program 25 is written in Labview. The host 20 comprises a monitor 24 for showing the testing result, so that the testing result can be viewed by the user.

For starting the keyboard testing method, a keyboard 21 to be tested should be connected with the host 20. The keyboard 21 comprises a plurality of ordinary keys 22 and at least one special key 23. Then, the keys of the keyboard 21 are sequentially tapped by the user or the keys of the keyboard 21 are sequentially and automatically tapped by a robotic arm or a striking hammer, so that corresponding key messages are outputted from the keyboard 21 to the host 20. Then, the steps of the keyboard testing method as shown in FIG. 2 are carried out. In the step 101, a key message outputted from the keyboard 21 is received. That is, when a key is tapped by the user, a corresponding key message is outputted from the keyboard 21 to the host 20. In a case that the tapped key is an ordinary key 22, the key message is an ordinary message 221. Whereas, in a case that the tapped key is a special key 23, the key message is a special message 231. For example, the special key is a sleep key, a wake key, a power off key or an eject key of the keyboard 21.

After the key message outputted from the keyboard 21 is received by the host 20, the step 102 is performed to detect whether the key message outputted to the host 20 is the special message 231. If the key message is not the special message 231, the key message is the ordinary message 221, and then the step 105 is performed. Whereas, if the key message is the special message 231, the step 103 is performed to intercept the special message 231 and convert a code of the special message 231. It is noted that the message intercept program 26 is a hook program. That is, in a case that the message intercept program 26 is installed in the host 20 under a Windows operating system, the message intercept program 26 is a message capture program at a lower level than the built-in hook program of the Windows operating system. The related technology is well known to those skilled in the art, and is not redundantly described herein.

After the special message 231 is received by the message intercept program 26, if a sleep key is depressed by the user for example, the code “0x02 0x02” of the special message 231 outputted to the host 20 will be intercepted by the message intercept program 26. After the special message 231 is intercepted, the message intercept program 26 will call a special key event that is previously stored in the message intercept program 26 according to a depressing status of the special message 231, thereby converting the code format of the special message into a format of a virtual key code (VK_code). That is, the depressing action of the ordinary key 22 will be simulated.

Hereinafter, the above procedures will be illustrated in more details. For performing procedure of converting the format of the code of the special message into the format of the virtual key code, the message intercept program 26 is designed to previously set an action of converting the special message into a virtual key code. Of course, the virtual key code is different from the virtual key code corresponding to the ordinary message 221, for example the ordinary message outputted form the ordinary key of the general keyboard. That is, the message intercept program 26 is designed to use the default virtual key codes of the Windows operating system which are not assigned to the keys of the general keyboard (e.g. the keys F13, F14, F15). For example, if the code “0x02 0x02” of the intercepted special message is converted into the virtual key code VK_F14, which is a virtual key code obtained by converting the key code of the key F14 after the key code of the key F14 is inputted into the host, the virtual key code VK_F14 will be distinguished from the virtual key codes of the converted ordinary messages. Under this circumstance, the possibility of resulting in erroneously judgment will be eliminated.

After the code of the special message 231 is converted, the converted special message 232 can be recognized by the keyboard testing program 25. Then, a step 104 is performed to receive the converted special message 232 and judge whether the code of the converted special message 232 is one of the default key codes. The key codes denote the default key codes of the keyboard testing program 25. In the Windows operating system, all ordinary keys have corresponding default virtual key codes. In addition, the keyboard testing program 25 is preset to contain these default virtual key codes for comparison. For example, after the virtual key code VK_F14 is received by the keyboard testing program 25, the keyboard testing program 25 will judge whether the virtual key code VK_F14 is one of the default virtual key codes. If the virtual key code VK_F14 is one of the default virtual key codes, the special key passes the test. Then, the step 106 is performed to judge whether all keys of the keyboard have been tested. In the judging condition is not satisfied, the step 107 is performed to show a testing result of the keyboard on the monitor to indicate that the special key does not pass the test. Moreover, the step 106 of judging whether all keys of the keyboard have been tested is performed by judging whether all default key codes have compiled virtual key codes. If the judging condition of the step 106 is satisfied, the keyboard 21 is determined as a qualified keyboard that passes the test, and then a message denoting that the keyboard 21 passes the test will be shown on the monitor. Whereas, if any key has not tested, the step 101 is repeatedly done.

Please refer to the block of the step 102 of detecting whether the key message outputted to the host 20 is the special message 231. If the key message is not the special message 231, the key message is the ordinary message 221, and then the step 105 is performed to process the ordinary message 221 and judge whether a code of the processed ordinary message is one of the default key codes. For processing the ordinary message 221, the ordinary message 221 is automatically converted into a corresponding virtual key code by a built-in program of the Windows operating system of the host 20. After the ordinary message 221 is automatically converted into a corresponding virtual key code, the keyboard testing program 25 can recognize and judge whether the virtual key code is one of the default key codes. If the judging condition of the step 105 is satisfied, the step 106 is performed to judge whether all keys of the keyboard have been tested. Whereas, if the judging condition of the step 105 is not satisfied, the step 107 is performed to show a failed test message of the keyboard on the monitor.

FIG. 4 schematically illustrates the testing result shown on a monitor during the keyboard testing method according to the present invention is performed. During the keyboard testing method is performed, the icons of all keys of the keyboard 21 are shown on the monitor 24 by the keyboard testing program 25. These icons include ordinary key icons 251 and special key icons 252. If the code of the converted special message 232 is one of the default key codes according to the judging condition of the step 104, the color of the special key icon 252 corresponding to the special message 231 and shown on the monitor will be changed. For example, as shown in the drawing, since the color of the special key icons 252 is changed, the user can realize the current testing status of the keyboard by viewing the monitor 24. It is noted that, in the step 104, the keyboard testing program 25 judges whether the code of the converted special message 232 is one of the default key codes according to the virtual key code corresponding to a nonexistent key (e.g. the key F14). However, since the keyboard testing program is written in a graphic editing language, the color of the special key icons 252 shown on the monitor 24 could be changed.

Similarly, if the virtual key code of the ordinary message 221 is one of the default key codes according to the judging condition of the step 105, the color of the ordinary key icon 251 corresponding to the ordinary message 221 and shown on the monitor 24 will be changed.

In some embodiments, the keyboard testing program 25 further comprises a predetermined key code script. The keyboard testing program 25 can automatically judge whether the virtual key codes are correct according to the predetermined key code script.

From the above description, the keyboard testing method of the present invention is capable of testing the special key of the keyboard by installing a message intercept program in a host. The message intercept program is configured to intercept the special message outputted from the keyboard and convert the code of the special message. In a case that the keyboard testing program has been installed in the host, the user can simply install the message intercept program to test all ordinary keys and all special keys of the keyboard without the need of rewriting the keyboard testing program.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keyboard testing method for testing a special message and an ordinary message outputted from a keyboard to a host, said special message being generated by tapping at least one special key, said ordinary message being generated by tapping at least one ordinary key, said special message and said ordinary message having different key code formats, said keyboard testing method comprising steps of:
(A) receiving a key message outputted from said keyboard;
(B) detecting whether said key message outputted to said host is said special message, wherein if said key message is said special message, a step (C) is performed, wherein if said key message is not said special message, said key message is said ordinary message and a step (E) is performed;
(C) intercepting said special message, and converting a code of said special message;
(D) receiving said converted special message, and judging whether said code of said converted special message is one of plural default key codes, wherein if said judging condition is satisfied, a step (F) is performed, wherein if said judging condition is not satisfied, a testing result of said keyboard is shown;
(E) processing said ordinary message and judging whether a code of said ordinary message is one of said default key codes, wherein if said judging condition is satisfied, said step (F) is performed, wherein if said judging condition is not satisfied, a testing result of said keyboard is shown; and
(F) judging whether all keys of said keyboard have been tested, wherein if said judging condition is satisfied, said step (A) is repeatedly done, wherein said judging condition is not satisfied, a testing result of said keyboard is shown.

2. The keyboard testing method according to claim 1 wherein said special key is a sleep key, a wake key, a power off key or an eject key of said keyboard.

3. The keyboard testing method according to claim 1 wherein said host further comprises a monitor for showing icons corresponding to all keys of said keyboard.

4. The keyboard testing method according to claim 3 wherein if said code of said converted special message is one of said default key codes according to said judging condition of said step (D), said keyboard testing method further comprises a step of changing a color of a special key icon shown on said monitor and corresponding to said special message, thereby facilitating a user to realize said testing result.

5. The keyboard testing method according to claim 3 wherein if a code of said ordinary message is one of said default key codes according to said judging condition of said step (E), said keyboard testing method further comprises a step of changing a color of an ordinary key icon shown on said monitor and corresponding to said ordinary message, thereby facilitating a user to realize said testing result.

6. The keyboard testing method according to claim 1 wherein said step (B) of detecting whether said key message outputted to said host is said special message and said step (C) of intercepting said special message and converting said code of said special message are executed by a message intercept program installed in said host.

7. The keyboard testing method according to claim 6 wherein said step (C) of converting said code of said special message is performed by calling a special key event previously stored in the message intercept program according to a depressing status of said special message, so that a code format of said special message is converted into a format of a virtual key code.

8. The keyboard testing method according to claim 1 wherein said step (D), said step (E) and said step (F) are executed by a keyboard testing program and a message intercept program installed in said host.

9. The keyboard testing method according to claim 1 wherein said step of processing said ordinary message is performed by converting said ordinary message into a corresponding virtual key code.
